(19) United States
(12) Patent Application Publication
(10) Pub. No.: US 2022/0231801 A1
(43) Pub. Date: Jul. 21, 2022

(54) APPARATUS AND METHOD FOR CONFIGURING APPLICATION OF TCI STATE TO COMPONENT CARRIERS

(71) Applicant: MEDIATEK INC., Hsin-Chu (TW)

(72) Inventor: Cheng-Rung Tsai, Hsin-Chu (TW)

(21) Appl. No.: 17/542,389

(22) Filed: Dec. 4, 2021

Related U.S. Application Data
(60) Provisional application No. 63/137,781, filed on Jan. 15, 2021.

(51) Int. Cl. H04L 5/00; H04W 72/04

(52) U.S. Cl. CPC H04L 5/001; H04W 72/042; H04W 72/0446

(57) ABSTRACT

Apparatus and methods are provided for configuring application of TCI state to CCs. In one novel aspect, a UE may apply one or more TCI states to a set of CCs based on a slot of a reference CC. In particular, a BS can transmit an indication of one or more TCI states to a UE. The UE can receive the indication of the one or more TCI states from the BS. Then, the can apply the one or more TCI states to a set of CCs from a specific slot of a reference CC. The reference CC may have a smallest SCS among the set of the CCs.

### CROSS REFERENCE TO RELATED APPLICATIONS

This application claims priority under 35 U.S.C. § 119 from U.S. Provisional Application No. 63/137,781, entitled “Common TCI Framework,” filed on Jan. 15, 2021, the subject matter of which is incorporated herein by reference.

### TECHNICAL FIELD

The disclosed embodiments relate generally to wireless communication, and, more particularly, to application of TCI state to component carriers.

### BACKGROUND

In conventional network of 3rd generation partnership project (3GPP) 5G new radio (NR), the user equipment (UE) can be configured, by the base station (BS), with a plurality of transmission configuration indication (TCI) states for downlink (DL) transmission and uplink (UL) transmission. After being configured, the UE may apply one or more TCI states indicated by the beam indication downlink control information (DCI) in the first slot that is at least ‘Y’ symbols after the last symbol of the acknowledgment of the beam indication DCI. Regarding a set of component carriers (CCs), the UE may apply the one or more indicated TCI states to the set of the CCs.

However, because different CCs may have different sub-carrier spacings (SCSs), the TCI state switching timing may not be aligned if the UE determines the first slot and ‘Y’ symbols separately in each CC for beam application time, which is very inefficient and can cause heavier network load.

### SUMMARY

Apparatus and methods are provided for configuring application of transmission configuration indication (TCI) state to component carriers (CCs). In one novel aspect, a user equipment (UE) may apply one or more TCI states to a set of CCs based on a slot of a reference CC. In particular, a base station (BS) can transmit an indication of one or more TCI states to a UE. The UE can receive the indication of the one or more TCI states from the BS. Then, the UE can apply the one or more TCI states to a set of CCs from a specific slot of a reference CC. The reference CC has a smallest sub-carrier space (SCS) among the set of CCs.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates an exemplary 5G new radio network supporting application of TCI state activation to reference signal in accordance with embodiments of the current invention.

FIG. 2 is a simplified block diagram of the gNB and the UE in accordance with embodiments of the current invention.

FIG. 3A illustrates one embodiment of message transmissions in accordance with embodiments of the current invention.

FIG. 3B illustrates one embodiment of a set of CCs utilized by UE in accordance with embodiments of the current invention.

FIG. 4A illustrates one embodiment of message transmissions in accordance with embodiments of the current invention.

FIG. 4B illustrates one embodiment of a set of CCs utilized by UE in accordance with embodiments of the current invention.

FIG. 5 is a flow chart of a method of configuring application of TCI state to CCs in accordance with embodiments of the current invention.

FIGS. 6A and 6B are flow charts of a method of configuring application of TCI state to CCs in accordance with embodiments of the current invention.

FIG. 7 is a flow chart of a method of configuring application of TCI state to CCs in accordance with embodiments of the current invention.

FIGS. 8A and 8B are flow charts of a method of configuring application of TCI state to CCs in accordance with embodiments of the current invention.

### DETAILED DESCRIPTION

Reference will now be made in detail to some embodiments of the invention, examples of which are illustrated in the accompanying drawings.

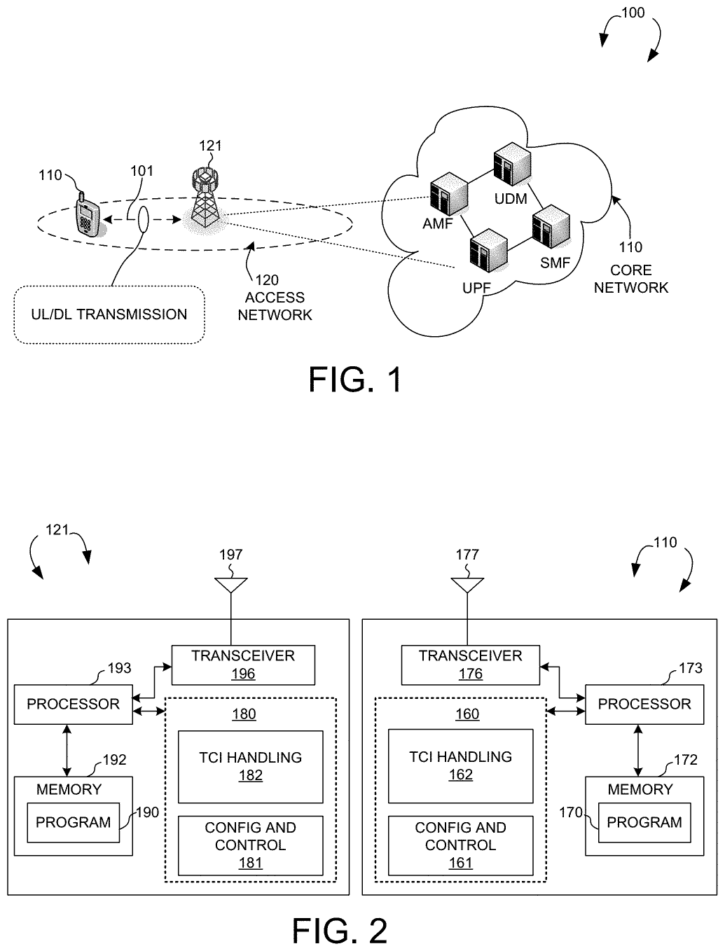

FIG. 1 illustrates an exemplary 5G new radio (NR) network 100 supporting application of transmission configuration indication (TCI) state to component carriers (CCs) in accordance with aspects of the current invention. The 5G NR network 100 includes a user equipment (UE) 110 communicatively connected to a gNB 121 operating in a licensed band (e.g., 30 GHz-300 GHz for mmWave) of an access network 120 which provides radio access using a Radio Access Technology (RAT) (e.g., the 5G NR technology). The access network 120 is connected to a 5G core network 130 by means of the NG interface, more specifically to a User Plane Function (UPF) by means of the NG user-plane part (NG-u), and to a Mobility Management Function (AMF) by means of the NG control-plane part (NG-c). One gNB can be connected to multiple UPFs/AMFs for the purpose of load sharing and redundancy. The UE 110 may be a smart phone, a wearable device, an Internet of Things (IoT) device, and a tablet, etc. Alternatively, UE 110 may be a Notebook (NB) or Personal Computer (PC) inserted or installed with a data card which includes a modem and RF transceiver(s) to provide the functionality of wireless communication.

The gNB 121 may provide communication coverage for a geographic coverage area in which communications with the UE 110 is supported via a communication link 101. The communication link 101 shown in the 5G NR network 100 may include uplink (UL) transmissions from the UE 110 to the gNB 121 (e.g., on the Physical Uplink Control Channel (PUCCH) or Physical Uplink Shared Channel (PUSCH)) or downlink (DL) transmissions from the gNB 121 to the UE 110 (e.g., on the Physical Downlink Control Channel (PDCCH) or Physical Downlink Shared Channel (PDSCH)).

FIG. 2 is a simplified block diagram of the gNB 121 and the UE 110 in accordance with embodiments of the present invention. For the gNB 121, an antenna 197 transmits and receives radio signal. A radio frequency (RF) transceiver module 196, coupled with the antenna, receives RF signals from the antenna, converts them to baseband signals and sends them to processor 193. RF transceiver 196 also converts received baseband signals from the processor 193, converts them to RF signals, and sends out to antenna 197. Processor 193 processes the received baseband signals and invokes different functional modules and circuits to perform features in the gNB 121. Memory 192 stores program instructions and data 190 to control the operations of the gNB 121.

Similarly, for the UE 110, antenna 177 transmits and receives RF signals. RF transceiver module 176, coupled with the antenna, receives RF signals from the antenna, converts them to baseband signals and sends them to processor 173. The RF transceiver 176 also converts received baseband signals from the processor 173, converts them to RF signals, and sends out to antenna 177. Processor 173 processes the received baseband signals and invokes different functional modules and circuits to perform features in the UE 110. Memory 172 stores program instructions and data 170 to control the operations of the UE 110.

The gNB 121 and the UE 110 also include several functional modules and circuits that can be implemented and configured to perform embodiments of the present invention. In the example of FIG. 2, the gNB 121 includes a set of control functional modules and circuit 180. TCI handling circuit 182 handles TCI state(s) and associated network parameters for the UE 110. Configuration and control circuit 181 provides different parameters to configure and control the UE 110. The UE 110 includes a set of control functional modules and circuit 160. TCI handling circuit 162 handles TCI state(s) and associated network parameters. Configuration and control circuit 161 handles configuration and control parameters from the gNB 121.

Note that the different functional modules and circuits can be implemented and configured by software, firmware, hardware, and any combination thereof. The function modules and circuits, when executed by the processors 193 and 173 (e.g., via executing program codes 190 and 170), allow the gNB 121 and the UE 110 to perform embodiments of the present invention.

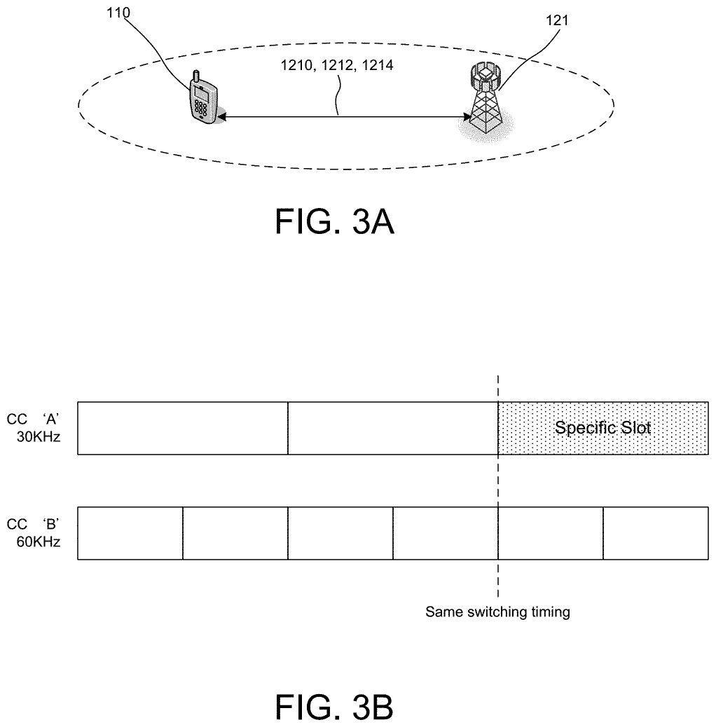

FIG. 3A illustrates one embodiment of message transmissions in accordance with one novel aspect. In particular, the gNB 121 transmits a higher layer configuration 1210 to the UE 110. The higher layer configuration 1210 configures the UE 110 a plurality of TCI states. The UE 110 receives the higher layer configuration 1210 from the gNB 121. After the transmission of the higher layer configuration 1210, the gNB 121 transmits a configuration 1212 to the UE 110. The configuration 1212 includes an indication 1214 of one or more indicated TCI states of the configured plurality of TCI states. The UE 110 receives the configuration 1212. In some embodiments, the higher layer configuration 1210 may include a radio resource control (RRC) configuration. In some embodiments, the configuration 1212 may include a downlink control information (DCI) so that the indication 1214 of one or more indicated TCI states is a DCI-based indication.

In some embodiments, after receiving the DCI-based indication 1214 of one or more indicated TCI states, the UE 110 can determine a reference CC from a set of CCs. The reference CC may have a smallest sub-carrier space (SCS) among the set of CCs. Then, the UE 110 can apply the one or more indicated TCI states to the set of CCs from a specific slot of the reference CC. In other words, after receiving the DCI-based indication 1214 of one or more indicated TCI states, the UE 110 can apply the one or more indicated TCI states to the set of CCs from the specific slot according to a reference SCS. The reference SCS is the smallest SCS among SCSs of the set of CCs.

FIG. 3B illustrates one embodiment of a set of CCs utilized by the UE 110 in accordance with one novel aspect. For example, two CCs ‘A’, ‘B’ are utilized by the UE 110. CC ‘A’ has SCS of 30 KHz. CC ‘B’ has SCS of 60 KHz. The UE 110 determines CC ‘A’ as a reference CC because the CC ‘A’ has the smallest SCS, which is 30 KHz, among the CCs ‘A’, ‘B’. Then, the UE 110 applies the one or more indicated TCI state to the CCs ‘A’, ‘B’ from a specific slot of the CC ‘A’. Accordingly, the one or more indicated TCI are applied to the CCs ‘A’, ‘B’ at the same switching timing.

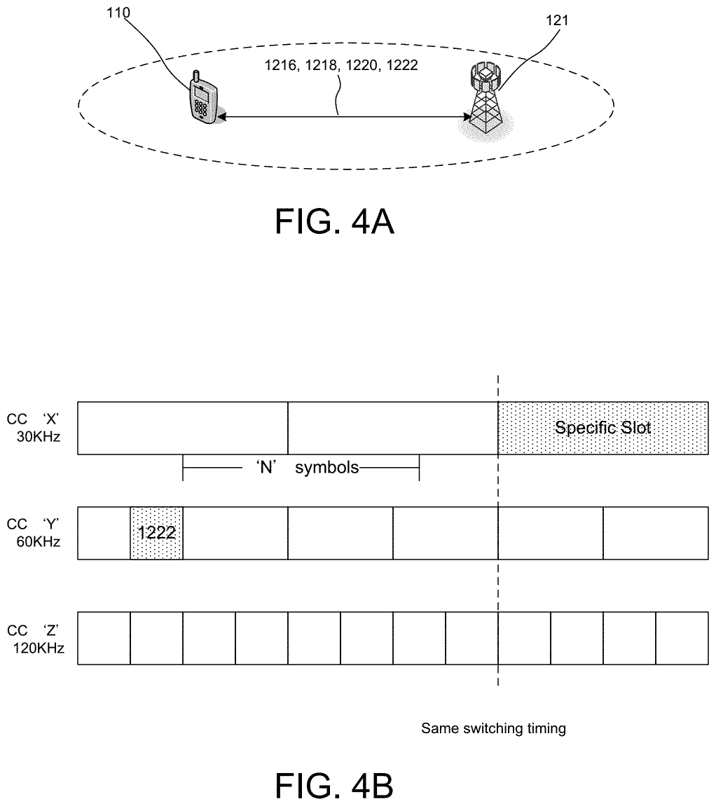

FIG. 4A illustrates one embodiment of message transmissions in accordance with one novel aspect. In particular, the gNB 121 transmits a higher layer configuration 1216 to the UE 110. The higher layer configuration 1216 includes a number of symbols, configures the UE 110 a set of CCs and a plurality of TCI states. The UE 110 receives the higher layer configuration 1218 from the gNB 121. After the transmission of the higher layer configuration 1216, the gNB 121 transmits a configuration 1218 to the UE 110. The configuration 1218 includes an indication 1220 of one or more indicated TCI states of the configured plurality of TCI states. The UE 110 receives the configuration 1218. In some embodiments, the higher layer configuration 1216 may include an RRC configuration. In some embodiments, the configuration 1218 may include a DCI so that the indication 1220 of one or more indicated TCI states is a DCI-based indication.

In some embodiments, after receiving the DCI-based indication 1220 of one or more indicated TCI states, the UE 110 can determine a reference CC from the set of CCs. The reference CC may have a smallest SCS among the set of CCs. More specifically, an active bandwidth part (BWP) of the reference CC has the smallest SCS among active BWPs of the set of CCs.

In other words, after receiving the DCI-based indication 1220 of one or more indicated TCI states, the UE 110 can apply the one or more indicated TCI states to the set of CCs from the specific slot according to a reference SCS. The reference SCS is the smallest SCS among SCSs of the set of CCs. The SCSs are configured to the active BWPs of the set of CCs.

Next, the UE 110 transmits an acknowledgement 1222 in response to the configuration 1218 (i.e., in response to the DCI) to the gNB 121. Then, the UE 110 can determine a specific slot and apply the one or more indicated TCI state to the set of CCs from the specific slot of the reference CC. The specific slot is the first slot of the reference CC after the number of symbols from a last symbol of transmitting the acknowledgment 1222 to the gNB 121. In other words, the specific slot is the first slot after the number of symbols, according to the reference SCS, from the last symbol of transmitting the acknowledgment 1222 to the network.

FIG. 4B illustrates one embodiment of a set of CCs utilized by the UE 110 in accordance with one novel aspect. For example, the number of symbols is ‘N’ and three CCs ‘X’, ‘Y’, ‘Z’ are utilized by the UE 110. CC ‘X’ has SCS of 30 KHz. CC ‘Y’ has SCS of 60 KHz. CC ‘Z’ has SCS of 120 KHz. The UE 110 determines CC ‘X’ as a reference CC because the active BWP of the CC ‘X’ has the smallest SCS, which is 30 KHz, among active BWPs of the CCs ‘X’, ‘Y’, ‘Z’. The UE 110 determines the specific slot that is the first slot of the CC ‘X’ after ‘N’ symbols from a last symbol of transmitting the acknowledgment 1222. Then, the UE 110 applies the one or more indicated TCI state to the CCs ‘X’, ‘Y’, ‘Z’ from the specific slot of the CC ‘X’. Accordingly, the one or more indicated TCI are applied to the CCs ‘X’, ‘Y’, ‘Z’ at the same switching timing.

In some embodiments, the gNB 121 can determine the number of symbols based on capability of the UE 110. In particular, the UE 110 can transmit a capability report to the gNB 121. The gNB 121 can determine the number of symbols according to the capability report of the UE 110 and transmit the number of symbols to the UE 110.

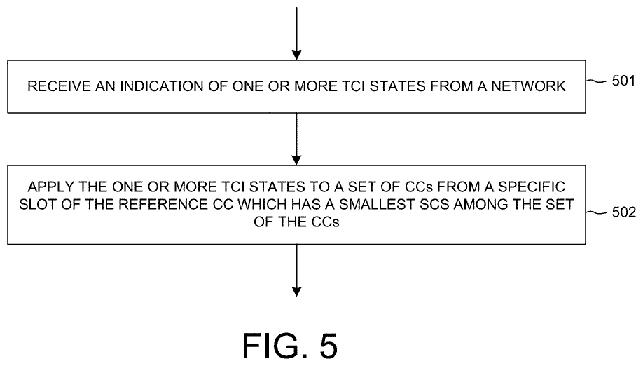

FIG. 5 is a flow chart of a method of configuring application of TCI state to CCs in a 5G/NR network in accordance with one novel aspect. In step 501, a UE receives an indication of one or more TCI states from a network. In step 502, the UE applies the one or more TCI states to a set of CCs from a specific slot of a reference CC which has a smallest SCS among the set of CCs.

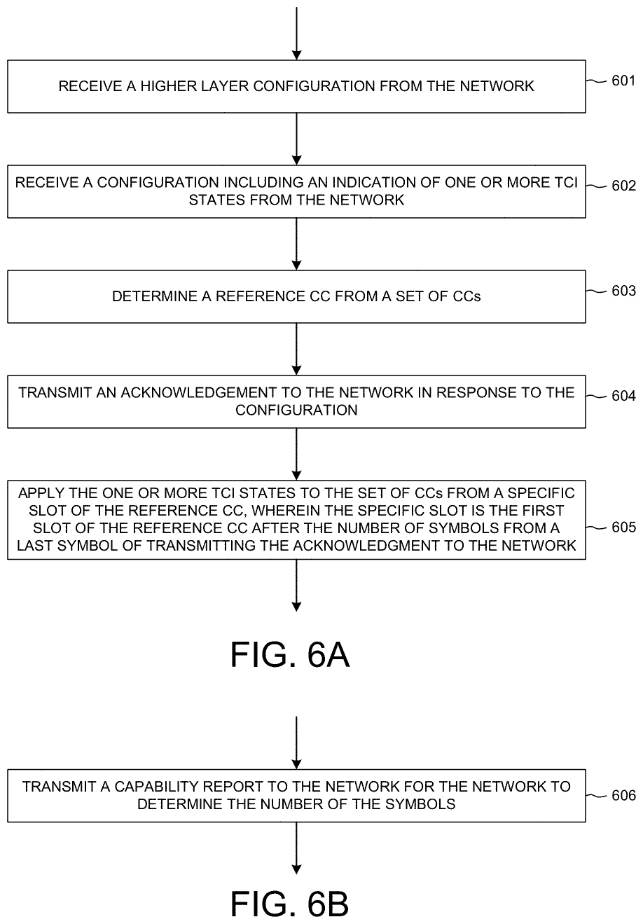

FIGS. 6A and 6B ae flow charts of a method of configuring application of one or more TCI states to CCs in a 5G/NR network in accordance with one novel aspect. In step 601, a UE receives a higher layer configuration from the network. The higher layer configuration includes a number of symbols, configures the UE a set of CCs and a plurality of TCI states. In step 602, the UE receives a configuration (e.g., DCI) including an indication of one or more TCI states. In step 603, the UE determines a reference CC from a set of CCs. An active BWP of the reference CC has the smallest SCS among active BWPs of the set of CCs. In step 604, the UE transmits an acknowledgement to the network in response to the configuration (e.g., DCI). In step 605, the UE applies the one or more TCI states to the set of CCs from a specific slot of the reference CC. The specific slot is the first slot of the reference CC after the number of symbols from a last symbol of transmitting the acknowledgment to the network.

In some embodiments, in an optional step 606, the UE transmits a capability report to the network for the network to determine the number of the symbols.

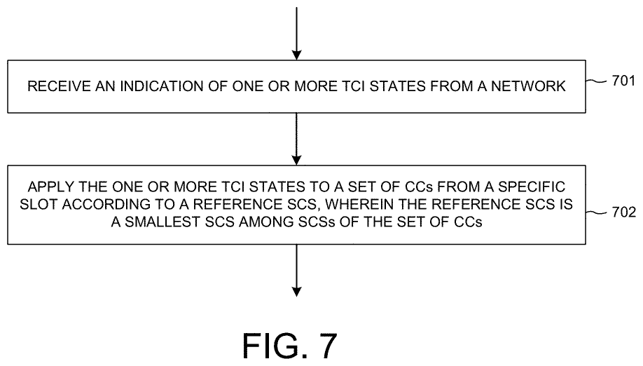

FIG. 7 is a flow chart of a method of configuring application of TCI state to CCs in a 5G/NR network in accordance with one novel aspect. In step 701, a UE receives an indication of one or more TCI states from a network. In step 702, the UE applies the one or more TCI states to a set of CCs from a specific slot according to a reference SCS. The reference SCS is a smallest SCS among SCSs of the set of CCs.

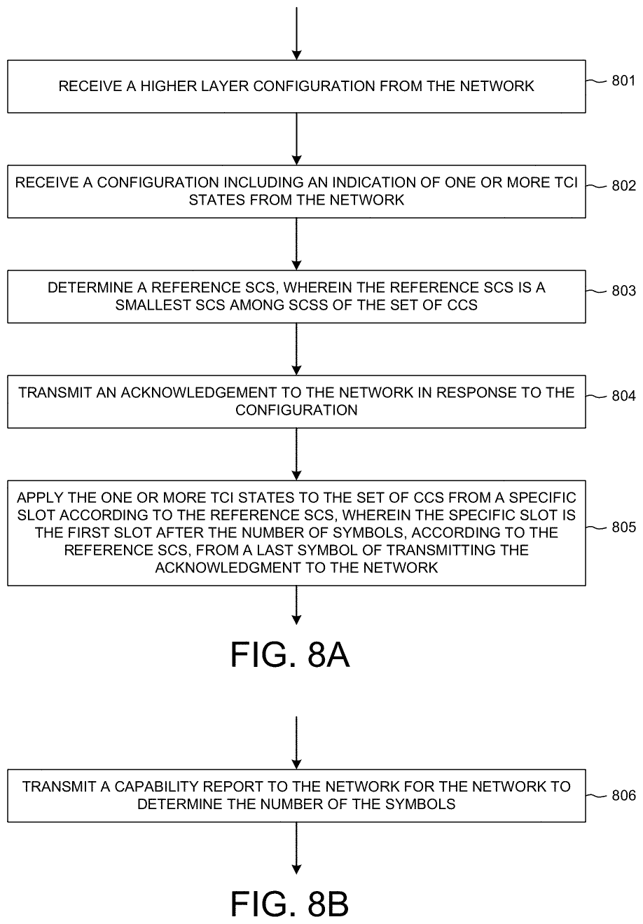

FIGS. 8A and 8B ae flow charts of a method of configuring application of TCI state to CCs in a 5G/NR network in accordance with one novel aspect. In step 801, a UE receives a higher layer configuration from the network. The higher layer configuration includes a number of symbols, configures the UE a set of CCs and a plurality of TCI states. In step 802, the UE receives a configuration (e.g., DCI) including an indication of one or more TCI states. In step 803, the UE determines a reference SCS. The reference SCS is a smallest SCS among SCSs of the set of CCs. The SCSs are configured to active BWPs of the set of CCs. In step 804, the UE transmits an acknowledgement to the network in response to the configuration (e.g., DCI). In step 805, the UE applies the one or more TCI states to the set of CCs from a specific slot according to the reference SCS. The specific slot is the first slot after the number of symbols, according to the reference SCS, from a last symbol of transmitting the acknowledgment to the network.

In some embodiments, in an optional step 806, the UE transmits a capability report to the network for the network to determine the number of the symbols.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method, comprising:
receiving, by a user equipment (UE), an indication of one or more transmission configuration indication (TCI) states from a network; and
applying, by the UE, the one or more TCI states to a set of component carries from a specific slot of a reference component carrier, wherein the reference component carrier has a smallest sub-carrier space among the set of component carriers.

2. The method of claim 1, wherein an active bandwidth part (BWP) of the reference component carrier has the smallest sub-carrier space among active BWPs of the set of component carriers.

3. The method of claim 1, further comprising:
receiving, by the UE, a number of symbols from the network,
wherein the specific slot is a first slot of the reference component carrier after the number of symbols from a last symbol of transmitting an acknowledgment to the network.

4. The method of claim 3, wherein the indication is included in a downlink control information (DCI).

5. The method of claim 4, further comprising:
transmitting, by the UE, the acknowledgement to the network in response to the DCI.

6. The method of claim 3, further comprising:
receiving, by the UE, a configuration from the network, wherein the set of component carriers is configured by the configuration.

7. The method of claim 6, wherein the configuration includes a radio resource control (RRC) configuration, and the number of symbols is included in the RRC configuration.

8. The method of claim 3, further comprising:
transmitting, by the UE, a capability report to the network for the network to determine the number of the symbols.

9. A method, comprising:
receiving, by a user equipment (UE), an indication of one or more transmission configuration indication (TCI) states from a network; and
applying, by the UE, the one or more TCI states to a set of component carries from a specific slot according to a reference sub-carrier space, wherein the reference sub-carrier space is a smallest sub-carrier space among sub-carrier spaces of the set of component carriers.

10. The method of claim 9, wherein the sub-carrier spaces are configured to active bandwidth parts (BWPs) of the set of component carriers.

11. The method of claim 9, further comprising:
receiving, by the UE, a number of symbols from the network,
wherein the specific slot is the first slot after the number of symbols, according to the reference sub-carrier space, from a last symbol of transmitting an acknowledgment to the network.

12. The method of claim 11, wherein the indication is included in a downlink control information (DCI).

13. A user equipment (UE) comprising:
a transceiver that:
receives an indication of one or more transmission configuration indication (TCI) states from a network; and
a TCI handling circuit that:
applies the one or more TCI states to a set of component carries from a specific slot of a reference component carrier, wherein the reference component carrier has a smallest sub-carrier space among the set of component carriers.

14. The UE of claim 13, wherein an active bandwidth part (BWP) of the reference component carrier has the smallest sub-carrier space among active BWPs of the set of component carriers.

15. The UE of claim 13, wherein the transceiver further receives a number of symbols from the network, and the specific slot is a first slot of the reference component carrier after the number of symbols from a last symbol of transmitting an acknowledgment to the network.

16. The UE of claim 15, wherein the indication is included in a downlink control information (DCI).

17. The UE of claim 16, wherein transceiver further transmits the acknowledgement to the network in response to the DCI.

18. The UE of claim 15, wherein transceiver further receives a configuration from the network, and the set of component carriers is configured by the configuration.

19. The UE of claim 18, wherein the configuration includes a radio resource control (RRC) configuration, and the number of symbols is included in the RRC configuration.

20. The UE of claim 15, wherein the transceiver further transmits a capability report to the network for the network to determine the number of the symbols.
